(19) United States
(12) Patent Application Publication
(10) Pub. No.: US 2019/0355952 A1
(43) Pub. Date: Nov. 21, 2019

(54) ELECTRODE ASSEMBLY, METHOD FOR PRODUCING SAME, AND SECONDARY BATTERY INCLUDING SAME

(71) Applicant: Samsung SDI Co., Ltd., Yongin-si, Giheung-gu (KR)

(72) Inventors: Yeonhee YOON, Yongin-si (KR); Junghyun NAM, Yongin-si (KR); Hoon SEOK, Yongin-si (KR); Heeeun YOO, Yongin-si (KR); Bokkyu JEON, Yongin-si (KR); Mokyun JIN, Yongin-si (KR)

(21) Appl. No.: 16/485,415

(22) PCT Filed: Feb. 5, 2018
(86) PCT No.: PCT/KR2018/001479

§ 371 Date: Aug. 12, 2019

(30) Foreign Application Priority Data
Feb. 22, 2017 (KR) 10-2017-0023607

(51) Int. Cl. H01M 2/16; H01M 4/62; H01M 2/14; H01M 10/0585

(52) U.S. Cl. CPC H01M 2/1673; H01M 10/0585; H01M 2/145; H01M 4/628

(57) ABSTRACT

The present disclosure relates to an electrode assembly, a method for producing the same, and a secondary battery including the same, the electrode assembly comprising: a negative electrode, in which a negative electrode current collecting layer, a negative electrode active material layer, and an insulation layer are sequentially laminated; a positive electrode; and a separator disposed between the negative electrode and the positive electrode, wherein a porosity of the insulation layer is 50% to 75%.

### CROSS-REFERENCE TO RELATED APPLICATION(S)

This application is a National Phase patent application of International Patent Application Number PCT/KR2018/001479, filed on Feb. 5, 2018, which claims priority of Korean Patent Application No. 10-2017-0023607, filed Feb. 22, 2017. The entire contents of both of which are incorporated herein by reference.

### TECHNICAL FIELD

This disclosure relates to an electrode assembly, a method of producing the same, and a secondary battery including the same.

### BACKGROUND ART

A portable information device such as a cell phone, a laptop, smart phone, and the like or an electric vehicle has used a lithium secondary battery having high energy density and easy portability as a driving power source. In addition, research on use of a lithium secondary battery as a power source for a hybrid or electric vehicle or a power storage by using high energy density characteristics has recently been actively made.

One of the main research tasks of such a lithium secondary battery is to improve the safety of the secondary battery. For example, if the lithium secondary battery is exothermic due to internal short circuit, overcharge and overdischarge, and the like, and an electrolyte decomposition reaction and thermal runaway phenomenon occur, an internal pressure inside the battery may rise rapidly to cause battery explosion. Among these, when the internal short circuit of the lithium secondary battery occurs, there is a high risk of explosion because the high electrical energy stored in each electrode is conducted in the shorted positive electrode and negative electrode.

Such an explosion merely gives the breakage of the lithium secondary battery and also may cause fatal damages to the user, so that it is urgent to develop a technique capable of improving stability of the lithium secondary battery.

### DETAILED DESCRIPTION OF THE INVENTION

### Technical Problem

An embodiment provides a secondary battery with improved stability while maintaining excellent battery performance.

### Technical Solution

In one aspect, the present disclosure provides an electrode assembly including a negative electrode, in which a negative electrode current collecting layer, a negative active material layer, and an insulation layer are sequentially laminated, positive electrode and a separator disposed between the negative electrode and the positive electrode, wherein a porosity of the insulation layer is 50% to 75%.

In another aspect, the present disclosure provides a method of producing an electrode assembly including forming an insulation layer on a negative electrode current collecting layer on which a negative active material layer is formed to produce a negative electrode, producing a positive electrode, and forming a separator between the negative electrode and the positive electrode, wherein the insulation layer is formed using an electrospinning method.

In another aspect, the present disclosure provides a secondary battery including another electrode assembly according to an embodiment of the present disclosure and an exterior material configured to accommodate the electrode assembly.

### Advantageous Effects

According to embodiments, the secondary battery of the present disclosure may achieve excellent charge and discharge characteristics while greatly improving stability.

### BRIEF DESCRIPTION OF THE DRAWINGS

FIG. 1 is a schematic view of a negative electrode included in an electrode assembly according to an embodiment of the present disclosure.

FIG. 2 shows an example of a secondary battery according to an embodiment of the present disclosure.

FIG. 3 is a cross-sectional SEM photograph of a negative electrode produced according to Example 1.

FIG. 4 shows a cross-sectional SEM photograph of the negative electrode measured after a penetration test for the secondary battery cell produced according to Example 1.

### MODE FOR INVENTION

Hereinafter, with reference to accompanying drawing, embodiments of the present invention are described so that the person skilled in the art can easily carry out the technique in which the present invention belongs. As those skilled in the art would realize, the described embodiments may be modified in various different ways, all without departing from the spirit or scope of the present invention. The contents which is not related to clearly describe the present invention are omitted from drawing and, and the same reference numerals designate the same or similar elements throughout the specification.

Sizes and thicknesses of components in the drawings are arbitrarily expressed for convenience of description and, thus, the present invention is not limited by the drawings. In the drawings, the thickness of layers, films, panels, regions, etc., are exaggerated for clarity. In addition, in the drawings, for convenience of description, thicknesses of a part and an area are exaggeratedly illustrated.

Further, it will be understood that when an element such as a layer, film, region, or substrate is referred to as being “on” or “above” another element, it can be directly on the other element or intervening elements may also be present. In contrast, when an element is referred to as being “directly on” another element, there are no intervening elements present. The word “on” or “above” means positioned on or below the object portion, and does not necessarily mean positioned on the upper side of the object portion based on a gravitational direction.

Furthermore, in the total specification, unless explicitly described to the contrary, the word “comprise” and variations such as “comprises” or “comprising”, will be understood to imply the inclusion of stated elements but not the exclusion of any other elements.

In addition, in this specification, the phrase “on a plane” means viewing a target portion from the top, and the phrase “on a cross-section” means viewing a cross-section formed by vertically cutting a target portion from the side.

An electrode assembly according to an embodiment of the present disclosure includes a negative electrode, a positive electrode, and a separator disposed between the negative electrode and the positive electrode.

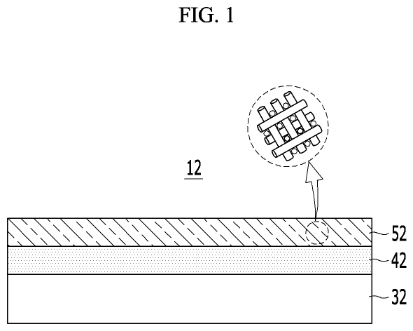

FIG. 1 schematically shows a negative electrode included in an electrode assembly according to an embodiment of the present disclosure.

Referring to FIG. 1, the negative electrode 12 may have a structure in which a negative electrode current collecting layer 32, a negative active material layer 42, and an insulation layer 52 are sequentially laminated.

The negative electrode current collecting layer 32 may include for example a copper foil, a nickel foil, a stainless steel foil, a titanium foil, a nickel foam, a copper foam, a polymer substrate coated with a conductive metal, and a combination thereof, but is not limited thereto.

A negative active material layer may be disposed on the at least one surface of the negative electrode current collecting layer 32. The negative active material layer 42 may be formed using negative electrode slurry including a negative active material and a negative conductive material.

The negative active material may be a carbon-based material where lithium ions are easily intercalated and deintercalated and thus high-rate charge and discharge characteristics are improved.

The carbon-based material may be crystalline carbon or amorphous carbon.

Examples of the crystalline carbon may be graphite.

Examples of the amorphous carbon may be soft carbon (low temperature fired carbon) or hard carbon, a mesophase pitch carbonized product, fired coke, and the like. For example, the carbon-based material may be soft carbon.

The soft carbon is graphitizable carbon in which atoms are aligned to easily form a layered structure, and thus the layered structure is easily changed into a graphite structure when heat-treated by increasing a temperature.

The soft carbon has a disordered crystal compared with graphite and thus more gates helping in and out of ions but is less disordered than hard carbon, so that the ions may be easily diffused. As specific examples, the carbon-based material may be low crystalline soft carbon.

On the other hand, an amount of the negative active material has no particular limit but may be in a range of 70 wt % to 99 wt % and specifically, 80 wt % to 98 wt % based on a total weight of negative electrode slurry.

The carbon-based material may have various shapes such as a sphere, a sheet, a flake, a fiber, and the like, for example, a needle.

On the other hand, the negative electrode slurry may include a negative conductive material.

The negative conductive material included to provide electrode conductivity may be any electrically conductive material may be used as a conductive material unless it causes a chemical change, and examples thereof are a carbon-based material such as natural graphite, artificial graphite, carbon black, acetylene black, ketjen black, a carbon fiber, and the like; a metal-based material of a metal powder or a metal fiber including copper, nickel, aluminum, silver, and the like; a conductive polymer such as a polyphenylene derivative; or a mixture thereof.

An amount of the negative conductive material may be 1.5 wt % to 40 wt %, and more specifically 1 wt % to 30 wt % or 2 wt % to 20 wt %. However, the amount of the negative conductive material may be appropriately adjusted depending on a type and an amount of the negative active material.

In the present disclosure, the negative electrode slurry includes 70 wt % to 98 wt % of the negative active material and 1.5 wt % to 40 wt % of the negative conductive material based on the total weight of the negative electrode slurry.

As needed, the negative electrode slurry may further include a binder. The binder improves binding properties of negative active material particles with one another and the negative active material with a current collector. The binder may be, for example, polyvinyl alcohol, carboxylmethyl cellulose, hydroxypropyl cellulose, polyvinylchloride, carboxylated polyvinylchloride, polyvinylfluoride, an ethylene oxide-containing polymer, polyvinylpyrrolidone, polyurethane, polytetrafluoroethylene, polyvinylidene fluoride, polyethylene, polypropylene, a styrene-butadiene rubber, an acrylated styrene-butadiene rubber, an epoxy resin, nylon, and the like, but is not limited thereto.

The insulation layer 52 may be disposed on the negative active material layer 42.

The insulation layer 52 may include a polymer and ceramic particulates. Herein, the polymer of the insulation layer 52 may be formed of a woven structure. These woven structures have pores inside and ceramic particulates are disposed in the pores. More specifically, the polymer is formed into a woven structure including pores therein, and the ceramic particles are disposed inside the woven structure.

If the insulation layer 52 is formed in a non-woven fabric shape instead of having a woven structure, the insulation layer 52 is difficult to satisfy the numeric range of porosity which will be described later, and a pore size is also excessively large, so it is highly possible to generate an internal short circuit when the negative electrode including the non-woven fabric insulation layer is employed in a secondary battery. Thus an insulation layer 52 included in the negative electrode 12 in the electrode assembly of the present disclosure desirably has a woven structure.

In this case, a porosity of the insulation layer 52 may be 50% to 75%, more specifically, may be 55% to 70%. When the porosity of the insulation layer 52 is greater than or equal to 50%, resistance of the negative electrode is increased to prevent the cell performance deterioration, and when the porosity is less than or equal to 75%, the stability to the electrode assembly of the present disclosure may be effectively improved.

A mixing weight ratio of the polymer and the ceramic particulates may be 20:80 to 85:15, more specifically, may be 30:70 to 70:30 or 30:70 to 50:50. When the mixing ratio of the polymer and the ceramic particulates satisfies the range, the satiability may be greatly improved while not decreasing the battery capacity when the negative electrode according to the present disclosure is applied to a secondary battery.

An average particle diameter of the ceramic particulates may be 0.1 μm to 4 μm, more specifically, may be 0.6 μm to 1 μm. When the average particle diameter of the ceramic particulates satisfies the range which is greater than or equal to 0.6 μm, it may prevent that the ceramic particulates are densely filled in pores, so that it may prevent increasing the resistance of the battery. In addition, when the average particle diameter of the ceramic particulates satisfies the range which is less than or equal to 4 μm, the polymer and the ceramic particulates may be easily performed with an electrospinning, and the obtained insulation layer has a structure that the ceramic particulates may be appropriately dispersed and positioned in the polymer. Accordingly, when the average particle diameter of the ceramic particulates satisfies the range, it may provide a lithium secondary battery with excellent performance while improving stability.

The polymer may be for example at least one selected from the group consisting of a copolymer of polyvinylidene fluoride and hexafluoropropylene (polyvinylidene fluoride-co-hexafluoropropylene, PVDF-HFP), polyacrylonitrile (PAN), polyimide (PI), polyethyleneimide (PEI), polypropylene (PP), polycarbonate (PC), and thermoplastic polyurethane (TPU), but is not limited thereto.

The ceramic particulates may be at least one selected from the group consisting of alumina (Al₂O₃), zirconia (ZrO₂), titanium oxide (TiO₂), and silica (SiO₂), but is not limited thereto.

In the present disclosure, the insulation layer 52 may be integrally formed with the negative active material layer 42. That is, a portion of the insulation layer 52 may be penetrated between the negative active material layers 42 to be formed into an integration shape. This is distinct from an interlayer structure of the separator and negative electrode 12 which will be described below. In the present disclosure, as the insulation layer 52 is integrally formed with the negative active material layer 42 as above, the negative electrode is prevented to be exposed, by itself, directly to the electrolyte solution and other materials, so minimizing unfavorable influences caused by side reactions between the negative electrode and the electrolyte solution.

In addition, as the insulation layer 52 is formed on the negative active material layer 42 using the electrospinning, the interface resist may be minimized, so as to favorably provide a battery having excellent performance.

Next, the positive electrode includes a positive electrode current collecting layer and a positive active material layer disposed at least one surface of the positive electrode current collecting layer.

The positive electrode current collecting layer serves to support the positive active material.

The positive electrode current collecting layer may use, for example, an aluminum foil, a nickel foil, or a combination thereof, but is not limited thereto.

In the positive active material layer, an amount of the positive active material may be 90 wt % to 98 wt % based on a total weight of the positive active material layer.

The positive active material may use a compound (lithiated intercalation compound) capable of intercalating and deintercallating lithium.

Specifically, at least one composite oxide of a metal selected from cobalt, manganese, nickel, and a combination thereof, and lithium may be used.

Specific examples thereof may be a compound represented by one of chemical formulae. LiₐA_{1-b}X_{b}D₂ (0.90≤a≤1.8, 0≤b≤0.5); LiₐA_{1-b}X_{b}O_{2-c}D_{c} (0.90≤a≤1.8, 0≤b≤0.5, 0≤c≤0.05); LiₐE_{1-b}X_{b}O_{2-c}D_{c} (0.90≤a≤1.8, 0≤b≤0.5, 0≤c≤0.05); LiₐE_{2-b}X_{b}O_{4-c}D_{c} (0.90≤a≤1.8, 0≤b≤0.5, 0≤c≤0.05); LiₐNi_{1-b-c}CO_{b}X_{c}D_{α} (0.90≤a≤1.8, 0≤b≤0.5, 0≤c≤0.5, 0≤α≤2); LiₐN_{1-b-c}CO_{b}X_{c}O_{2-α}T_{α} (0.90≤a≤1.8, 0≤b≤0.5, 0≤c≤0.05, 0<α<2); LiₐNi_{1-b-c}CO_{b}X_{c}O_{2-α}T₂ (0.90≤a≤1.8, 0≤b≤0.5, 0≤c≤0.05, 0<α<2); LiₐNi_{1-b-c}Mn_{b}X_{c}D_{α} (0.90≤a≤1.8, 0≤b≤0.5, 0≤c≤0.05, 0<α<2); LiₐNi_{1-b-c}Mn_{b}X_{c}O_{2-α}T_{α} (0.90≤a≤1.8, 0≤b≤0.5, 0≤c≤0.05, 0<α<2); LiₐNi_{1-b-c}Mn_{b}X_{c}O_{2-α}T₂ (0.90≤a≤1.8, 0≤b≤0.5, 0≤c≤0.05, 0<α<2); LiₐNi_{b}E_{c}G_{d}O₂ (0.90≤a≤1.8, 0≤b≤0.9, 0≤c≤0.5, 0.001≤d≤0.1); LiₐNi_{b}Co_{c}Mn_{d}GeO₂ (0.90≤a≤1.8, 0≤b≤0.9, 0≤c≤0.5, 0≤d≤0.5, 0.001≤e≤0.1); LiₐNiG_{b}O₂ (0.90≤a≤1.8, 0.001≤b≤0.1) LiₐCoG_{b}O₂ (0.90≤a≤1.8, 0.001≤b≤0.1); LiₐMn_{1-b}G_{b}O₂ (0.90≤a≤1.8, 0.001≤b≤0.1); LiₐMn₂G_{b}O₄ (0.90≤a≤1.8, 0.001≤b≤0.1); LiₐMn_{1-g}G_{g}PO₄ (0.90≤a≤1.8, 0≤g≤0.5); QO₂, QS₂, LiQS₂, V₂O₅, LiV₂O₅, LiZO₂, LiNiVO₄, Li_{(3-f)}J₂(PO₄)₃ (0≤f≤2); Li_{(3-f)}Fe₂(PO₄)₃ (0≤f≤2); LiₐFePO₄ (0.90≤a≤1.8)

In chemical formulae, A is selected from the group consisting of Ni, Co, Mn, and a combination thereof; X is selected from the group consisting of Al, Ni, Co, Mn, Cr, Fe, Mg, Sr, V, a rare earth element, and a combination thereof; D is selected from the group consisting of O, F, S, P, and a combination thereof; E is selected from the group consisting of Co, Mn, and a combination thereof; T is selected from the group consisting of F, S, P, and a combination thereof; G is selected from the group consisting of Al, Cr, Mn, Fe, Mg, La, Ce, Sr, V, and a combination thereof; Q is selected from the group consisting of Ti, Mo, Mn, and a combination thereof; Z is selected from the group consisting of Cr, V, Fe, Sc, Y, and a combination thereof; and J is selected from the group consisting of V, Cr, Mn, Co, Ni, Cu, and a combination thereof.

The compounds may have a coating layer on the surface or may be mixed with another lithium metal oxide having a coating layer. The coating layer may include at least one coating element compound selected from the group consisting of an oxide of a coating element, a hydroxide of a coating element, an oxyhydroxide of a coating element, an oxycarbonate of a coating element, and a hydroxy carbonate of a coating element. The compound for the coating layer may be amorphous or crystalline. The coating element included in the coating layer may include Mg, Al, Co, K, Na, Ca, Si, Ti, V, Sn, Ge, Ga, B, As, Zr, or a mixture thereof. The coating layer may be disposed by a method having no adverse influence on properties of a positive active material by using these elements in the compound, for example, spray coating, dipping, etc. However, the coating method is not limited thereto, and a detailed description thereof will be omitted because it is well understood by those skilled in the art.

In an embodiment of the present disclosure, the positive active material layer may include a binder and a positive conductive material. Herein, the binder and the conductive material may be included in an amount of 1 wt % to 5 wt %, respectively based on a total amount of the positive active material layer.

The binder improves binding properties of positive active material particles with one another and with a current collector, and examples thereof may be polyvinyl alcohol, carboxylmethyl cellulose, hydroxypropyl cellulose, diacetyl cellulose, polyvinylchloride, carboxylated polyvinylchloride, polyvinylfluoride, an ethylene oxide-containing polymer, polyvinylpyrrolidone, polyurethane, polytetrafluoroethylene, polyvinylidene fluoride, polyethylene, polypropylene, a styrene-butadiene rubber, an acrylated styrene-butadiene rubber, an epoxy resin, nylon, and the like, but are not limited thereto.

The conductive material is included to provide a positive electrode with conductivity and may be any material having electron conductivity may be used as a conductive material unless it causes a chemical change in a battery including the same. The positive conductive material may be for example a carbon-based material such as natural graphite, artificial graphite, carbon black, acetylene black, ketjen black, a carbon fiber, and the like; a metal-based material of a metal powder or a metal fiber including copper, nickel, aluminum, silver, and the like; a conductive polymer such as a polyphenylene derivative; or a mixture thereof.

On the other hand, the separator separates a positive electrode and a negative electrode and provides a transporting passage for lithium ions and may be any generally-used separator in a lithium secondary battery.

In other words, it may have low resistance to ion transport and excellent impregnation for an electrolyte.

The separator may be, for example, selected from a glass fiber, polyester, polyethylene, polypropylene, polytetrafluoroethylene, or a combination thereof. It may have a form of a non-woven fabric or a woven fabric.

For example, in a lithium secondary battery, a polyolefin-based polymer separator such as polyethylene and polypropylene is mainly used, in order to ensure the heat resistance or mechanical strength, a separator coated with a composition including a ceramic component or a polymer material may be used, and optionally, it may have a mono-layered or multi-layered structure.

In another aspect, a method of producing an electrode assembly according to an embodiment of the present disclosure includes forming an insulation layer on a negative electrode current collecting layer on which a negative active material layer is formed to produce a negative electrode, producing a positive electrode and forming a separator between the negative electrode and the positive electrode.

Herein, the insulation layer is formed by performing using an electrospinning method.

As described above, the present disclosure is characterized in that the insulation layer includes a woven structure, wherein the woven structure is obtained by forming the insulation layer using an electrospinning method.

In this case, the electrospinning process may be performed using a mixture of the polymer and the ceramic particulates. In this case, a mixing ratio of the polymer and the ceramic particulates is same as above, so is omitted in here.

In another aspect, a secondary battery according to an embodiment of the present disclosure includes an electrode assembly and an exterior material configured to accommodate the electrode assembly.

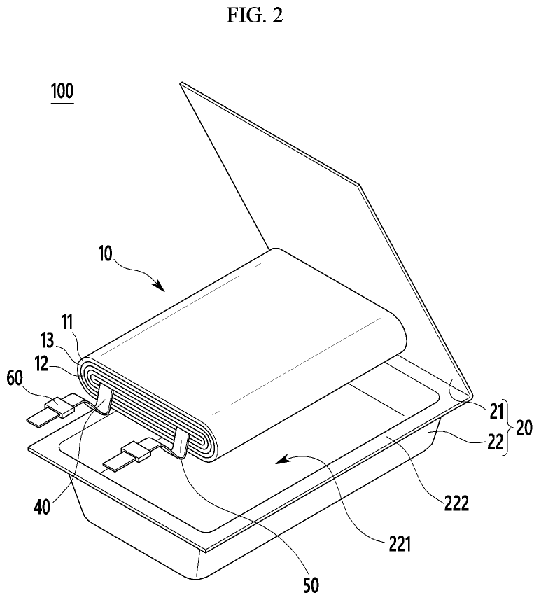

FIG. 2 shows a schematic representation of a secondary battery according to an embodiment of the present disclosure.

Referring to FIG. 2, a secondary battery 100 according to an embodiment of the present disclosure includes a case 20, an electrode assembly 10 inserted in case 20, and a positive terminal 40 and a negative terminal 50 which are electrically connected to the electrode assembly 10.

Since the secondary battery 100 of the present disclosure includes the aforementioned electrode assembly, detailed description of each configuration of the electrode assembly 10 is the same as above, and will not be described here.

On the other hand, the electrode assembly 10, as shown in FIG. 2, may have a structure obtained by interposing a separator 13 between band-shaped positive electrode 11 and negative electrode 12, spirally winding them, and compressing it into flat. In addition, even though not shown, a plurality of quadrangular sheet-shaped positive and negative electrodes may be alternately laminated with a plurality of separator therebetween.

The case 20 may be composed of a lower case 22 and an upper case 21, and the electrode assembly 10 is accommodated in inner space 221 of the lower case 22.

After the electrode assembly 10 is accommodated in the inner space 221 of the lower case 22, the upper case 21 and the lower case 22 are sealed by applying a sealant to a sealing portion 222 disposed at the edge of the lower case 22. Herein, parts where the positive terminal 40 and the negative electrode terminal 50 are in contact with the case 20 may be wrapped with an insulation member 60 to improve durability of the lithium secondary battery 100.

On the other hand, the positive electrode 11, the negative electrode 12, and the separator 13 may be immersed in an electrolyte.

The electrolyte includes a non-aqueous organic solvent and a lithium salt.

The non-aqueous organic solvent serves as a medium for transmitting ions taking part in the electrochemical reaction of a battery.

The non-aqueous organic solvent may include a carbonate-based, ester-based, ether-based, ketone-based, alcohol-based, or aprotic solvent. The carbonate-based solvent may include dimethyl carbonate (DMC), diethyl carbonate (DEC), dipropyl carbonate (DPC), methylpropyl carbonate (MPC), ethylpropyl carbonate (EPC), methylethyl carbonate (MEC), ethylene carbonate (EC), propylene carbonate (PC), butylene carbonate (BC), and the like and the ester-based solvent may include methyl acetate, ethyl acetate, n-propyl acetate, dimethyl acetate, methyl propionate, ethyl propionate, γ-butyrolactone, decanolide, valerolactone, mevalonolactone, caprolactone, and the like. The ether-based solvent may include dibutyl ether, tetraglyme, diglyme, dimethoxyethane, 2-methyltetrahydrofuran, tetrahydrofuran, and the like and the ketone-based solvent may include cyclohexanone, and the like. The alcohol based solvent may include ethanol, isopropyl alcohol, and the like, and the aprotic solvent may include nitriles such as R—CN (wherein R is a C2 to C20 linear, branched, or cyclic hydrocarbon group, or may include a double bond, an aromatic ring, or an ether bond), and the like, amides such as dimethyl formamide, and the like, dioxolanes such as 1,3-dioxolane, and the like, sulfolanes, and the like.

The non-aqueous organic solvent may be used singularly or in a mixture, when the organic solvent is used in a mixture, a mixture ratio may be controlled in accordance with a desirable battery performance, and it may be well understood to one of the related arts.

In addition, the carbonate-based solvent is prepared by mixing a cyclic carbonate and a linear carbonate. When the cyclic carbonate and linear carbonate are mixed together in a volume ratio of 1:1 to 1:9, an electrolyte solution performance may be improved.

The non-aqueous organic solvent of the present disclosure may further include an aromatic hydrocarbon-based organic solvent in addition to the carbonate-based solvent. Herein, the carbonate-based solvent and the aromatic hydrocarbon-based organic solvent may be mixed in a volume ratio of 1:1 to 30:1.

The aromatic hydrocarbon-based organic solvent may be an aromatic hydrocarbon-based compound of Chemical Formula 1.

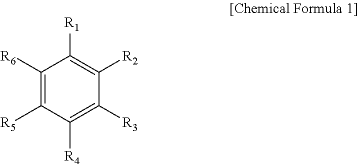

In Chemical Formula 1, R₁ to R₆ are the same or different and are selected from hydrogen, a halogen, a C1 to C10 alkyl group, a haloalkyl group, and a combination thereof.

Specific examples of the aromatic hydrocarbon-based organic solvent may be selected from the group consisting of benzene, fluorobenzene, 1,2-difluorobenzene, 1,3-difluorobenzene, 1,4-difluorobenzene, 1,2,3-trifluorobenzene, 1,2,4-trifluorobenzene, chlorobenzene, 1,2-dichlorobenzene, 1,3-dichlorobenzene, 1,4-dichlorobenzene, 1,2,3-trichlorobenzene, 1,2,4-trichlorobenzene, iodobenzene, 1,2-diiodobenzene, 1,3-diiodobenzene, 1,4-diiodobenzene, 1,2,3-triiodobenzene, 1,2,4-triiodobenzene, toluene, fluorotoluene, 2,3-difluorotoluene, 2,4-difluorotoluene, 2,5-difluorotoluene, 2,3,4-trifluorotoluene, 2,3,5-trifluorotoluene, chlorotoluene, 2,3-dichlorotoluene, 2,4-dichlorotoluene, 2,5-dichlorotoluene, 2,3,4-trichlorotoluene, 2,3,5-trichlorotoluene, iodotoluene, 2,3-diiodotoluene, 2,4-diiodotoluene, 2,5-diiodotoluene, 2,3,4-triiodotoluene, 2,3,5-triiodotoluene, xylene, and a combination thereof.

The non-aqueous electrolyte may further include vinylene carbonate or an ethylene carbonate-based compound of Chemical Formula 2 in order to improve a cycle-life of a battery.

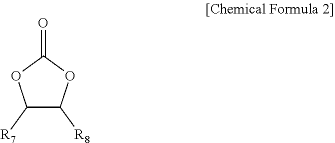

In Chemical Formula 2, R₇ and R₈ are the same or different and selected from hydrogen, a halogen, a cyano group (CN), a nitro group (NO₂), and a fluorinated C1 1 to C5 alkyl group, provided that at least one of R₇ and R₈ is a halogen, a cyano group (CN), a nitro group (NO₂), and a fluorinated C1 1 to C5 alkyl group, and R₇ and R₈ are not simultaneously hydrogen.

Examples of the ethylene carbonate-based compound may be difluoro ethylenecarbonate, chloroethylene carbonate, dichloroethylene carbonate, bromoethylene carbonate, dibromoethylene carbonate, nitroethylene carbonate, cyanoethylene carbonate, fluoroethylene carbonate, and the like. The amount of the additive for improving a cycle-life may be used within an appropriate range.

The lithium salt dissolved in an organic solvent supplies lithium ions in a battery, enables a basic operation of a lithium secondary battery, and improves transportation of the lithium ions between positive and negative electrodes. Examples of the lithium salt include at least one supporting salt selected from LiPF₆, LiBF₄, LiSbF₆, LiAsF₆, LiN(SO₂C₂F₅)₂, Li(CF₃SO₂)₂N, LiN(SO₃C₂F₅)₂, LiC₄F₉SO₃, LiClO₄, LiAlO₂, LiAlCl₄, LiN(CₓF₂ₓ₊₁SO₂)(C_{y}F_{2y+1}SO₂), (wherein x and y are natural numbers, e.g., an integer of 1 to 20), LiCl, LiI, and LiB(C₂O₄)₂ (lithium bis(oxalato) borate; LiBOB). The lithium salt may be used in a concentration ranging from 0.1 M to 2.0 M. When the lithium salt is included at the above concentration range, an electrolyte may have excellent performance and lithium ion mobility due to optimal electrolyte conductivity and viscosity.

### EXAMPLES

Hereinafter, the disclosure will be specifically examined through Examples.

### Example 1

### (1) Production of Negative Electrode

90 wt % of an artificial graphite negative active material and 10 wt % of a polyvinylidene fluoride binder were mixed in an N-methyl pyrrolidone solvent to provide a negative active material slurry.

The negative active material slurry was coated on a Cu foil in a thickness of 10 μm and dried at 100° C. and then pressed to provide a negative active material layer.

An insulation layer is formed on the negative active material layer using a mixture that PVdF-HFP and Al₂O₃ were mixed at a weight ratio of 50:50 according to an electrospinning to provide a negative electrode.

In this case, an average particle diameter of the alumina particulate was 0.6 μm, and a porosity of the insulation layer was 55%.

### (2) Production of Secondary Battery Cell

The negative electrode according to (1), a lithium metal counter electrode, and an electrolyte solution were used to manufacture a coin-shaped half-cell in a common method. The electrolyte solution was prepared by dissolving 1.0 M LiPF₆ in a mixed solvent of ethylene carbonate and diethyl carbonate (a volume ratio of 50:50).

### Example 2

A negative electrode and a secondary battery were manufactured in accordance with the same procedure as in Example 1, except that the insulation layer was obtained using a mixture that a mixing weight ratio of PVdF-HFP and Al₂O₃ was 30:70. In this case, a porosity of the insulation layer was 55%.

### Example 3

A negative electrode and a secondary battery were manufactured in accordance with the same procedure as in Example 1, except that the insulation layer was formed using alumina particulates having an average particle diameter of 0.8 μm. In this case, a porosity of the insulation layer was 60%.

### Example 4

A negative electrode and a secondary battery were manufactured in accordance with the same procedure as in Example 1, except that the insulation layer was formed using alumina particulates having an average particle diameter of 0.5 μm. In this case, a porosity of the insulation layer was 55%.

### Comparative Example 1

A negative electrode and a secondary battery were manufactured in accordance with the same procedure as in Example 1, except that the insulation layer was formed using only alumina particulates having an average particle diameter of 0.8 μm. In this case, a porosity of the insulation layer was 50%.

### Comparative Example 2

A negative electrode and a secondary battery were manufactured in accordance with the same procedure as in Example 1, except that the insulation layer was formed using only PVdF-HFP. In this case, a porosity of the insulation layer was 85%.

### Comparative Example 3

A negative electrode and a secondary battery were manufactured in accordance with the same procedure as in Example 1, except that the insulation layer was formed to have a porosity of 20%. The porosity was controlled by controlling a speed of movement of the coating surface during electrospinning.

### Comparative Example 4

A negative electrode and a secondary battery were manufactured in accordance with the same procedure as in Example 1, except that the insulation layer was formed to have a porosity of 90%.

The porosity was controlled by controlling a speed of movement of the coating surface during electrospinning.

### Experimental Example 1—Penetration Test

Secondary battery cells obtained from Examples 1 to 4 and Comparative Examples 1 to 4 were prepared at a full charged state of 4.35 V. Then the secondary battery cell was performed with a penetration test by penetrating the center of the secondary battery by a nail made of iron (Fe) and having a diameter of 2.5 mm, using a penetration test machine. In this case, the penetration speed of the nail was constantly 12 m/min.

After the penetration test, the results according to evaluation references of Table 1 are shown in Table 2.

TABLE 1

| | Level | | | | | | | |
|---|---|---|---|---|---|---|---|---|
| | Level 3 | Level 4 | Level 4-1 | Level 4-2 | Level 4-3 | Level 5 | Level 6 | Level 7 |
| Reference | No | Vent | Just | Short | Flame | Fire | Rupture | Explosion |
| | Event | | Smoke | Spark | (1 sec. ↑) | (5 sec. ↑) | | |

TABLE 2

| | Configuration of insulation | | | |
|---|---|---|---|---|
| | layer of negative electrode | | | |
| | | Average | | |
| | Mixing | particle | | |
| | ratio of | diameter of | | |
| | polymer and | ceramic | Porosity of | |
| | ceramic | particulates | insulation | Penetration test |
| Division | particulates | (μm) | layer (%) | result (Level) |
| Example 1 | 50:50 | 0.6 | 55 | L4-2 |
| Example 2 | 30:70 | 0.6 | 55 | L3 |
| Example 3 | 50:50 | 0.8 | 60 | L4-2 |
| Example 4 | 50:50 | 0.5 | 55 | L3 |
| Comparative | 0:100 | 0.8 | 50 | L4 |
| Example 1 | | | | |
| Comparative | 100:0 | — | 85 | L6 |
| Example 2 | | | | |
| Comparative | 50:50 | 0.6 | 20 | L6 |
| Example 3 | | | | |
| Comparative | 50:50 | 0.6 | 90 | L6 |
| Example 4 | | | | |

### Experimental Example 2—Measurement of Charge and Discharge Characteristics and Capacity Retention

The secondary battery cells obtained from Examples 1 to 4, Comparative Examples 1 to 4, and Reference Example 1 were charged and discharged at 25° C. within a range of 2.8 V to 4.4 V and a current of 0.2 C rate, and initial charge and discharge characteristics were evaluated, then the initial discharge capacity is shown in Table 3.

A ratio of 50th discharge capacity to first discharge capacity was calculated to provide a capacity retention, which is referred to as a cycle-life.

TABLE 3

| | | | 50^{th}/1^{st} |
|---|---|---|---|
| | Initial charge | Initial discharge | capacity |
| | capacity | capacity | retention |
| Division | [mAh/g] | [mAh/g] | (%) |
| Example 1 | 2654.77 | 2548.58 | 91 |
| Example 2 | 2673.96 | 2540.26 | 89 |
| Example 3 | 2646.19 | 2548.28 | 90 |
| Example 4 | 2670.89 | 2532 | 87 |
| Comparative Example 1 | 2100.27 | 2016.26 | 82 |
| Comparative Example 2 | 2662.61 | 2542.79 | 92 |
| Comparative Example 3 | 2225.64 | 2136.61 | 83 |
| Comparative Example 4 | 2657.71 | 2538.11 | 91 |

Referring to Tables 2 and 3, the secondary battery cells according to Examples 1 to 4 including the negative electrode formed with the insulation layer having a porosity range from 50 to 75% exhibited a penetration test result of less than or equal to L4-2, so it is confirmed that the stability was very excellent. In addition, it is confirmed that the charge and discharge characteristics and the capacity retention were also not deteriorated.

However, the secondary battery cells according to Comparative

Examples 2 to 4 including the negative electrode formed with the insulation layer having a porosity out of the range showed a penetration level of L6 in the penetration test results. In other words, when the penetration tests regarding the lithium secondary battery cells according to Comparative Examples 2 to 4 were performed, the temperature of the lithium secondary battery cells sharply increased up to 400° C. to 500° C. and started to be swollen along with gas eruption and electrolyte solution-scattering and to occur large spark for 5 seconds or more and simultaneously exploded. Accordingly, they showed sharply deteriorated stability compared with the cells according to an embodiment of the present disclosure. In addition, the secondary battery cell according to Comparative Example 1 showed a relatively excellent stability as the penetration test results of L4, but the capability retention was sharply deteriorated compared with the secondary battery cells according to Examples 1 to 4.

### Experimental Example 3—Measurement of Cross-Sectional SEM Photograph

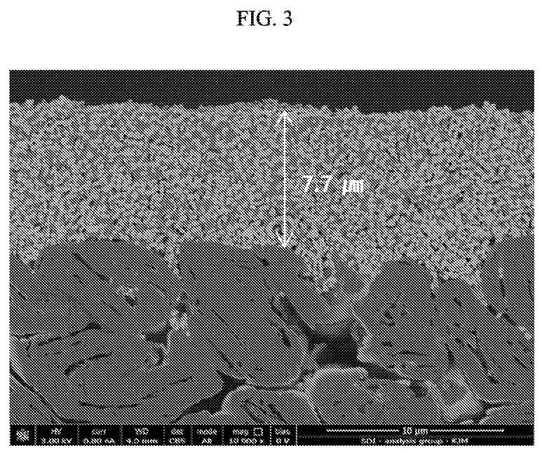

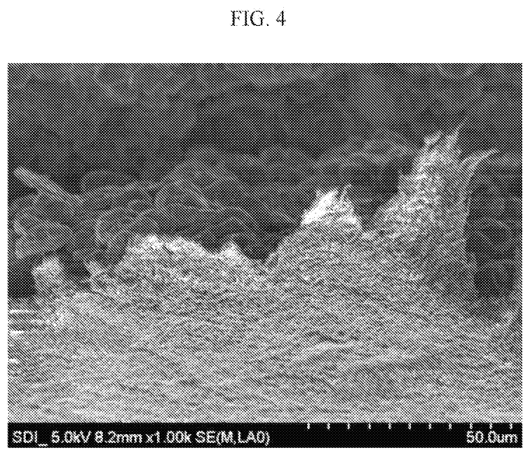

FIG. 3 is a SEM photograph showing a cross-sectional surface of the negative electrode obtained from Example 1 measured in a magnification of ×1,000, and FIG. 4 is a SEM photograph showing a cross-sectional surface of the negative electrode on which SEM photograph was taken in the same magnification, measured in a magnification of ×1,000 after performing the secondary battery cell according to Example 1 with the penetration test.

Referring to FIG. 3, it is confirmed that an insulation layer was formed on the negative active material layer in a predetermined thickness.

In addition, referring to FIG. 4, it is confirmed that the insulation layer of the negative electrode was deformed to wrap the ruptured surface, after the penetration test. Accordingly, it prevented a short circuit with the positive electrode, so it is confirmed that the stability of the secondary battery cell was improved.

While this invention has been described in connection with what is presently considered to be practical embodiments, it is to be understood that the invention is not limited to the disclosed embodiments, and on the contrary, it is intended to cover various modifications and equivalent arrangements included within the spirit and scope of the appended claims.

### DESCRIPTION OF SYMBOLS

100: secondary battery
10: electrode assembly
11: positive electrode
12: negative electrode
32: negative electrode current collecting layer
42: negative active material layer
53: insulation layer
13: separator
20: exterior material

1. An electrode assembly comprising
a negative electrode, in which a negative electrode current collecting layer, a negative active material layer, and an insulation layer are sequentially laminated;
a positive electrode; and
a separator disposed between the negative electrode and the positive electrode,
wherein a porosity of the insulation layer is 50% to 75%.

2. The electrode assembly of claim 1, wherein the insulation layer has a woven structure.

3. The electrode assembly of claim 1, wherein the insulation layer comprises a polymer and ceramic particulates.

4. The electrode assembly of claim 3, wherein a mixing ratio of the polymer and the ceramic particulates is 20:80 to 85:15.

5. The electrode assembly of claim 3, wherein an average particle diameter of the ceramic particulates is within a range of 0.1 μm to 4 μm.

6. The electrode assembly of claim 3, wherein the polymer is at least one selected from the group consisting of a copolymer of polyvinylidene fluoride and hexafluoropropylene (polyvinylidene fluoride-co-hexafluoropropylene, PVDF-HFP), polyacrylonitrile (PAN), polyimide (PI), polyethyleneimide (PEI), polypropylene (PP), polycarbonate (PC), and thermoplastic polyurethane (TPU).

7. The electrode assembly of claim 3, wherein the ceramic particulates are at least one selected from the group consisting of alumina (Al₂O₃), zirconia (ZrO₂), titanium oxide (TiO₂), and silica (SiO₂).

8. The electrode assembly of claim 1, wherein the insulation layer is integrally formed with the negative active material layer.

9. A method of producing an electrode assembly, comprising
forming an insulation layer on a negative electrode current collecting layer on which a negative active material layer is formed to produce a negative electrode;
producing a positive electrode; and
forming a separator between the negative electrode and the positive electrode,
wherein the insulation layer is formed using an electrospinning method.

10. The method of producing an electrode assembly of claim 9, wherein the electrospinning is performed using a mixture of a polymer and ceramic particulates.

11. The method of producing an electrode assembly of claim 10, wherein a mixing ratio of the polymer and the ceramic particulates is 20:80 to 85:15.

12. A secondary battery comprising
an electrode assembly of claim 1; and
an exterior material configured to accommodate the electrode assembly.
